(19) United States
(12) Patent Application Publication
(10) Pub. No.: US 2018/0253723 A1
(43) Pub. Date: Sep. 6, 2018

(54) SYSTEM AND METHOD FOR DETERMINING A PROFILE OF A CONSUMER

(71) Applicant: MASTERCARD ASIA/PACIFIC PTE. LTD., Singapore (SG)

(72) Inventors: Donghao Huang, Singapore (SG); Krishnadas Mohandas, Singapore (SG); Bo Zeng, Singapore (SG); Hui Fang, Singapore (SG); Xijing Wang, Singapore (SG)

(73) Assignee: MASTERCARD ASIA/PACIFIC PTE. LTD., Singapore (SG)

(21) Appl. No.: 15/910,793

(22) Filed: Mar. 2, 2018

(30) Foreign Application Priority Data
Mar. 2, 2017 (SG) 10201701697X

(51) Int. Cl. G06Q 20/36; G06Q 20/34; G06Q 20/24

(52) U.S. Cl. CPC G06Q 20/363; G06Q 20/24; G06Q 20/34

(57) ABSTRACT

A system and a method for determining a profile of a consumer are disclosed. The system includes a processor and a memory unit coupled to the processor. The memory unit is configured to store the consumer's payment card usage data. The processor is configured to obtain a credit score specific to the consumer and calculate a payment card index specific to the consumer based on the consumer's payment card usage data stored in the memory unit. The payment card index may comprise a weighted sum of factors representative of the consumer's payment card usage. The processor is also configured to multiply the credit score by the payment card index to obtain a collective score representative of the profile of the consumer.

### CROSS-REFERENCE TO RELATED APPLICATIONS

This application claims the priority of Singapore Application Serial No. 10201701697X, filed Mar. 2, 2017, which is incorporated herein by reference in its entirety.

### BACKGROUND

The present disclosure relates broadly, but not exclusively, to systems and methods for determining a profile of a consumer, for providing information to the consumer based on the profile of the consumer, and for processing a payment card application based on the profile of the consumer.

Payment cards have been in use for decades and it is common for an average consumer to have multiple payment cards to take advantage of their respective benefits, for example, offers, loyalty/reward points, payment schedules, etc. More recently, with the widespread ownership of smartphones and tablet computers, digital wallets (also referred to as mobile wallets) are increasingly being adopted as a secure and convenient mode of electronic payment.

While a digital wallet can store details of different payment cards owned by a consumer, the consumer often still faces difficulty in finding the best deal nearby that matches with those cards. Typically, the consumer would need to ask the merchant, refer to advertisements or promotional materials in the merchant's premises, or find out from other sources, e.g. friends, or the Internet. If the consumer then realizes that he/she does not have the payment card that provides the best deal, it is usually too late to get that card to immediately enjoy the benefits. The typical payment card application is tedious to the consumer and usually requires submission of “know your customer” (KYC) information, such as personal information and supporting documents such as proof of salary, etc., before approval is granted by the payment card issuer.

A need therefore exists to provide a system and method that can quickly predict or respond to the consumer's needs in such situations.

### SUMMARY

A first aspect of the present disclosure provides a system for determining a profile of a consumer, comprising a processor and a memory unit coupled to the processor. The memory unit is configured to store the consumer's payment card usage data. The processor is configured to obtain a credit score specific to the consumer and calculate a payment card index specific to the consumer based on the consumer's payment card usage data stored in the memory unit. The payment card index may comprise a weighted sum of factors representative of the consumer's payment card usage. The processor is also configured to multiply the credit score by the payment card index to obtain a collective score representative of the profile of the consumer.

The payment card index may comprise a value between 0 and 1, and the factors representative of the consumer's payment card usage may each comprise a value between 0 and 1.

The factors representative of the consumer's payment card usage may comprise a factor representative of a total number of payment cards issued by different payment card issuers to the consumer.

The factors representative of the consumer's payment card usage may further comprise a factor representative of a number of bad spending records by the consumer.

The factors representative of the consumer's payment card usage may further comprise a factor representative of a number of payment card transactions made by the consumer within a predetermined period of time.

The factors representative of the consumer's payment card usage may further comprise a factor representative a number of payment card transactions made by the consumer relative to the consumer's current location.

The present disclosure also provides a system for providing information to a consumer, comprising a processor and a memory unit coupled to the processor. The memory unit is configured to receive data representing the profile of the consumer from the system as defined in the first aspect. The processor is configured to analyze the received data and generate merchant information for delivery to the consumer based on the profile of the consumer.

The system may be further configured to deliver the merchant information to the consumer in real-time based on a location of the consumer.

The present disclosure also provides a system for processing a payment card application from a consumer, comprising a processor and a memory unit coupled to the processor. The memory unit is configured to receive payment card application data from the consumer and data representing the profile of the consumer from the system as defined in the first aspect. The processor is configured to analyze the received data and process the payment card application based on the profile of the consumer.

The system may be configured to process the payment card application in real-time, and automatically add details of an approved payment card to a digital wallet of the consumer.

A second aspect of the present disclosure provides a method for determining a profile of a consumer. Using a processor, a credit score specific to the consumer is obtained and a payment card index specific to the consumer is calculated. The payment card index may comprise a weighted sum of factors representative of the consumer's payment card usage. The method also includes multiplying, by the processor, the credit score by the payment card index to obtain a collective score representative of the profile of the consumer.

The payment card index may comprise a value between 0 and 1, and the factors representative of the consumer's payment card usage may each comprise a value between 0 and 1.

The factors representative of the consumer's payment card usage may comprise a factor representative of a total number of payment cards issued by different payment card issuers to the consumer.

The factors representative of the consumer's payment card usage may further comprise a factor representative of a number of bad spending records by the consumer.

The factors representative of the consumer's payment card usage may further comprise a factor representative of a number of payment card transactions made by the consumer within a predetermined period of time.

The factors representative of the consumer's payment card usage may further comprise a factor representative a number of payment card transactions made by the consumer relative to the consumer's current location.

The present disclosure also provides a method of providing information to a consumer. The method comprises analyzing the profile of the consumer obtained according to the method as defined in the second aspect, and delivering merchant information to the consumer based on the profile of the consumer.

The merchant information may be delivered to the consumer in real-time based on the consumer's location.

The present disclosure also provides a method of processing a payment card application. The method comprises receiving the payment card application from a consumer, analyzing the profile of the consumer obtained according to the method as defined in the second aspect, and processing the payment card application based on the profile of the consumer.

The steps of receiving, analyzing and processing may be performed in real-time, and the method may further comprise automatically adding details of an approved payment card to a digital wallet of the consumer.

### BRIEF DESCRIPTION OF THE DRAWINGS

Embodiments of the present disclosure will be better understood and readily apparent to one of ordinary skill in the art from the following written description, by way of example only, and in conjunction with the drawings, in which:

FIG. 1 shows a flow chart illustrating a method for determining a profile of a consumer according to an example embodiment.

FIG. 2 shows a schematic block diagram illustrating an implementation of a system for determining a profile of a consumer according to an example embodiment.

FIG. 3 shows a flow chart illustrating a method of handling an electronic transaction with a consumer according to an example embodiment.

FIGS. 4a-4f show screen images of a user interface implementing the method of FIG. 3 according to an example embodiment.

FIG. 5 shows a schematic block diagram illustrating a wireless device suitable for implementing the method of the example embodiments.

FIG. 6 shows a schematic block diagram illustrating a computer suitable for implementing the method and system of the example embodiments.

### DETAILED DESCRIPTION

The example embodiments provide a system and method for determining a profile of a consumer, such as a payment card user. The consumer profile can be used, for example, by merchants in providing real-time information to the consumer, or by payment card issuers in real-time processing of a payment card application.

The example embodiments will now be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM, GPRS, 3G or 4G mobile telephone systems, as well as other wireless systems such as Bluetooth, ZigBee, Wi-Fi. The computer program when loaded and executed on such a computer effectively results in an apparatus that implements the steps of the preferred method.

The present invention may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC) or Field Programmable Gate Array (FPGA). Numerous other possibilities exist. Those skilled in the art will appreciate that the system can also be implemented as a combination of hardware and software modules.

The present disclosure relates to methods for determining or constructing a profile of a payment card consumer. Currently, many merchants accept electronic payment transactions as an alternative to cash for the payment for products. In such electronic payment transactions, a payment card may be used. As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, and/or computers. In other words, in some instances, such a payment card may not exist in a physical form, but rather, may be in an electronic form comprising data stored in a digital (i.e. mobile) wallet.

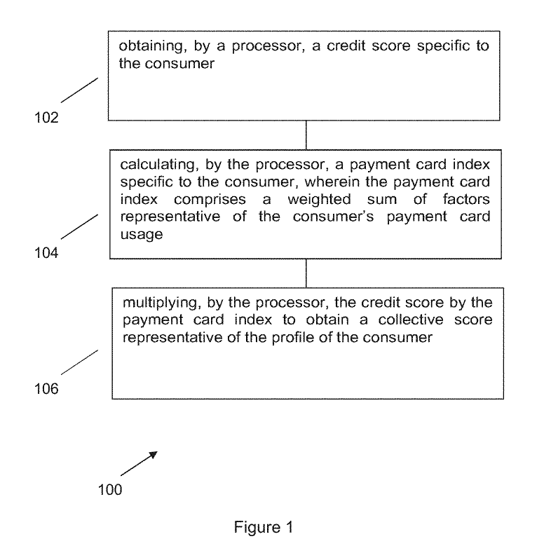

FIG. 1 shows a flow chart 100 illustrating a method for determining a profile of a consumer according to an example embodiment. At step 102, a credit score specific to the consumer is obtained by a processor. At step 104, a payment card index specific to the consumer is calculated by the processor. As described in more detail below, the payment card index comprises a weighted sum of factors representative of the consumer's payment card usage. At step 106, the processor carries out an operation of multiplying the credit score by the payment card index, to obtain a collective score representative of the profile of the consumer.

As would be appreciated by a person skilled in the field, a credit score of a consumer is typically calculated based on credit report information from credit bureaus, and is normally used to assess the creditworthiness of the consumer. Various methodologies exist to determine a consumer's credit score, which normally has a numerical value, and each business or financial institution may have a preferred scoring method. An example of a credit score is the FICO® score created by Fair Isaac Corporation. In some embodiments, the credit score may be acquired from an external source, for example, a payment card issuer, a lender, or a credit reporting agency such as Experian.

The payment card index in the example embodiment is a measure representative of the consumer's payment card usage, and can be formulated using information including, but not limited to, the consumer's spending history (e.g. type of merchants/goods of the consumer's payment card transactions, amount spent, frequency of transactions, etc.), consumer's location (e.g. geographic coordinates, map data, etc.), consumer's banking/payment card information (e.g. number of payment cards owned, fraudulent/bad spending records, overdue records, etc.). Other attributes or factors can be added or substituted in order to create an index according to a business' specific needs. For example, a merchant selling a certain product would be interested in a factor representing a match between that product and product(s) most commonly purchased by the consumer. A payment card issuer, on the other hand, would likely be interested in factors associated with credit risks beyond those provided by the existing credit score.

Further, the payment card index in the example embodiment is specific to the consumer and not limited to payment cards issued by a specific payment card issuer (e.g. a bank or credit institution) to the consumer. The payment card index is also based on a set of factors, including, for example, a temporal factor (e.g. frequency of the transactions by the consumer) and a spatial factor (e.g. location of the transactions by the consumer). An advantage of aggregating these factors into the payment card index is the creation of a more complete representation of the consumer's spending habits and payment records, so that predictive or prompt service offerings can be delivered to the consumer.

Typically, the data used to calculate the payment card index can be collected from each electronic payment transaction made by the consumer. For example, within the same payment card network (e.g. MasterCard®), each consumer may be assigned a unique ID, which is common across different card types and programs and to which the relevant data is associated. Such data is normally securely stored in a database maintained by the payment card network.

In one example, the collective score in step 106 can be calculated using the following formula:

Collective Score=Traditional Score*(f1*w1+f2*w2+f3*w3+f4*w4)

where Traditional Score is a credit score and (f1*w1+f2*w2+f3*w3+f4*w4) is the payment card index in the form of a weighted sum, and where fi∈[0,1] and Σᵢ₌₁⁴wi=1. In other words, each factor fi is in the form of a numerical value between 0 and 1 and the sum of weights wi is 1. Accordingly, the payment card index is in the form of a numerical value between 0 and 1. Here, four factors are used to obtain the weighted sum but it would be understood that more or fewer factors can be used in alternate embodiments.

The factors fi may include a factor representative of a total number of payment cards issued by different payment card issuers to the consumer, which may be calculated using the following equation:

$$f 1 = {\sum }_{i = 1}^{4} ui * \frac{min ( xi , Mi )}{Mi}$$

where xi is the number of cards issued by a respective payment card issuer or group of issuers to the consumer, Mi has a predetermined value, e.g. 10, and each issuer has a weight ui. For example, if four issuers or groups of issuers are used and each has equal weightage, ui=0.25. Alternatively, a higher weightage may be assigned to an issuer who has a greater interest in the consumer's payment card index, for example, if the issuer already has an existing relationship with the consumer and is being requested to issue a new payment card to the consumer.

The factors fi may further include a factor representative of a number of bad spending records by the consumer, which may be calculated using the following equation:

$$f 2 = 1 - \frac{\# ( bad history records )}{\# ( total history records )}$$

where “history records” may mean payment card transactions or settlements of such transactions, and a bad record may include, but are not limited to, a fraudulent transaction (chargeback, block, etc.), delinquency, late payment, etc.

The factors fi may further include a factor representative of a number of payment card transactions made by the consumer within a predetermined period of time, which may be calculated using the following function:

$$f 3 ( x ) = \{ \begin{matrix}10 \% if x == 0 \\ 50 \% if x > 0 and x < T \\ 100 \% if x \geq T\end{matrix}$$

where x is the number of transactions made by the consumer over that period, e.g. two months, and T has a predetermined value, e.g. T=10. The transactions can be limited to those made via a mobile wallet, or alternatively, can also include point of sale (POS)-based transactions and/or web-based transactions. The factor thus generated may be indicative of how active or prolific the consumer is.

The factors fi may further include a factor representative a number of payment card transactions made by the consumer relative to the consumer's current location, which may be calculated using the following function:

$$f 4 ( x ) = \{ \begin{matrix}20 \% if x \geq 1000 km ; \\ 30 \% if x \geq 200 km and x < 1000 km ; \\ 50 \% if x \geq 1 km and x < 200 km ; \\ 100 \% if x < 1 km\end{matrix}$$

where x is determined based on the locations of the consumer's transactions, e.g. over the past year, relative to the consumer's current location. For example, x can be the minimum of the distances of such transactions from the consumer's current location. The factor thus generated may be indicative of the consumer's spending patterns, such as the locations frequently patronized by the consumer, so that the relevant product or service offerings may be provided to the consumer with a higher chance of being taken up by the consumer. Also, this factor can provide some measure of the credit risk in case the payment card details are stolen and used at a location far from the consumer.

After the factors are calculated, each factor fi is given a weight wi, for example, w₁=35%, w₂=30%, w₃=25% and w₄=10% in the above example. It will be appreciated that the weights may be adjusted in alternate embodiments depending on their relative importance or relevance. For example, a merchant may give greater weights to certain factors than a payment card issuer such as a bank. The collective score thus obtained may be representative of the profile of the consumer in relation to the objectives and interests of the merchant or bank who may make use of the score.

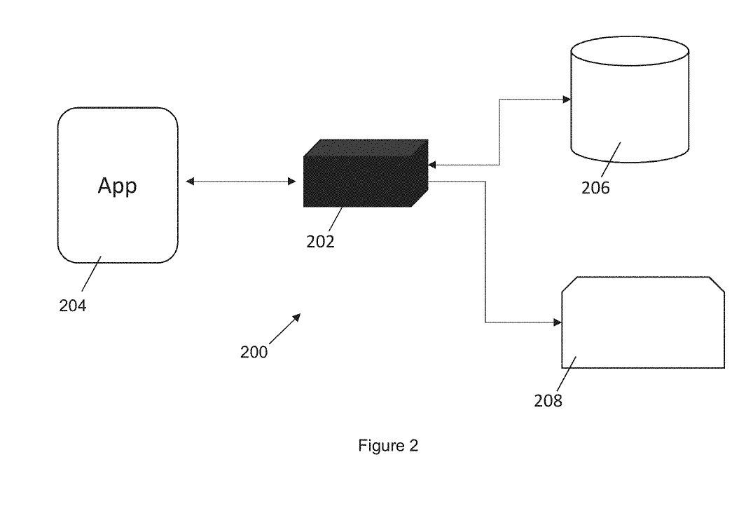

FIG. 2 shows a schematic block diagram 200 illustrating an implementation of a system 202 for determining a profile of a consumer according to an example embodiment. The system 202 can be in the form of a computer or server that is in communication with a consumer device 204, a merchant database 206 and a card network database 208 to obtain the relevant inputs for further processing. The consumer device 204 may be a mobile phone, a tablet or laptop computer that can provide information such as location data, as well as relevant data stored in a mobile wallet app running in the consumer device 204. The merchant database 206 can provide information about the location, products, promotions, deals, etc. of one or more merchants. The card network database 208 can provide information about past transactions by the consumer, the number of cards issued to the consumer, etc. The output from the system 202, e.g. in the form of customer IDs and their respective scores, can be securely stored and accessed in real-time upon request, or alternatively, be provided to trusted partners such as payment card issuers.

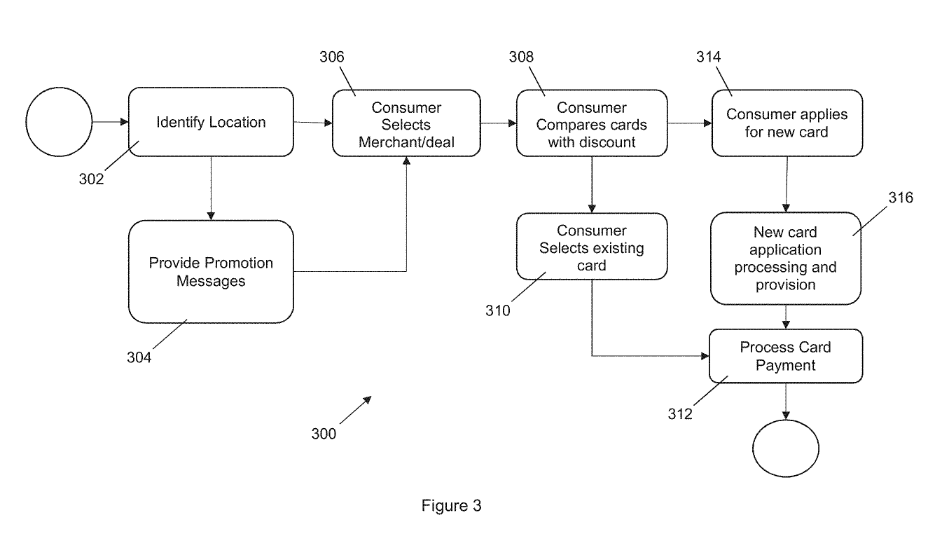

FIG. 3 shows a flow chart 300 illustrating a method of handling an electronic transaction with a consumer according to an example embodiment. At step 302, the location of the consumer is identified, for example, based on location data provided by the consumer device 204 (FIG. 2). At step 304, promotional information, such as deals, loyalty points, rewards, etc., is provided to the consumer in real-time based on the location of the consumer. The promotional information can be customized according to the profile of the consumer as determined using the method as described above with reference to FIG. 1. Based on the promotional information, the consumer may proceed to select a merchant and/or deal at step 306. For example, if the consumer is in a mall, the promotional information may include multiple relevant merchants and their respective deals, for selection by the consumer. Alternatively, the consumer may directly select a merchant and/or deal at step 306 without having been taken through step 304, for example, if the consumer is already in a store or restaurant and is about to check out.

At step 308, the consumer may compare the respective discounts or promotions applied to different payment cards. If there is an existing card with the desired discount, the consumer selects that card at step 310, for example, from a digital wallet app running on the consumer device 204. The payment is then processed at step 312. Alternatively, if the consumer does not have a suitable payment card with the desired discount, the consumer can apply for a new card at step 314. At step 316, the payment card application from the consumer is processed in real-time according to the profile of the consumer as determined using the method as described above with reference to FIG. 1, and if the payment card application is approved, the new card is automatically added to the digital wallet of the consumer. The consumer can immediately use the newly approved card for the payment step 312 to enjoy the benefits.

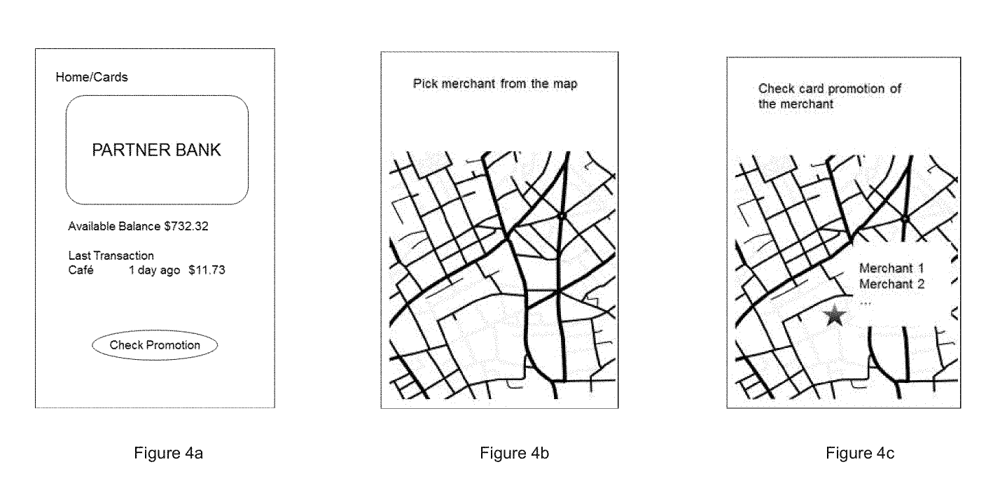

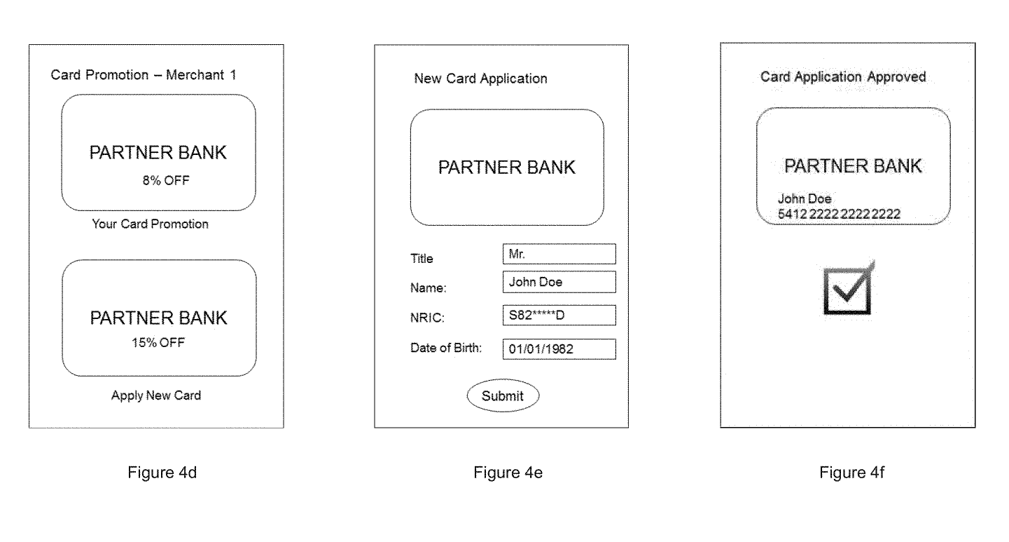

FIGS. 4a-4f show screen images of a user interface implementing the method of FIG. 3 according to an example embodiment. For example, FIG. 4a shows a screen where the consumer may initiate a check of promotion information for the cards stored in his/her digital wallet. FIG. 4b shows a screen having a map that can be provided with the consumer's location and names and/or icons denoting merchants on the map. FIG. 4c shows a screen where the consumer can view and select the merchant and/or deal, for example, from a list. FIG. 4d shows a screen where the consumer can compare different cards and their respective discounts, including existing card(s) as well as recommended card(s) which the consumer may be prompted to apply for immediately. FIG. 4e shows a screen of an application form where the consumer can apply for a recommended payment card. FIG. 4f shows a screen having a confirmation that a new card has been approved and the card details added to the digital wallet app. It will be appreciated that FIGS. 4a-4f may not be arranged sequentially. It will be further appreciated that there are various ways of designing an interface, e.g. through the use of icons, lists, prompts, etc., to implement the present method.

As described, the method and system of the example embodiments can provide an adaptable way of building a multi-facet profile of a consumer. Such a profile can be used multiple times by relevant stakeholders during a shopping or dining experience by the consumer so that the consumer may enjoy the best possible deal every time. In other words, not only the consumer's satisfaction is improved but the stakeholders (e.g. merchants, issuers) may also benefit from being able to offer the right product or services to the right target consumer at the right time. Specifically, merchants can rely on the system to push real-time personalized promotion to customers on site, for example, about either luxury products or affordable ones. Issuers can create a new credit account, adjust credit limit, or block usage dynamically based on the profile and upon customer's request, etc. in order to minimize the risks.

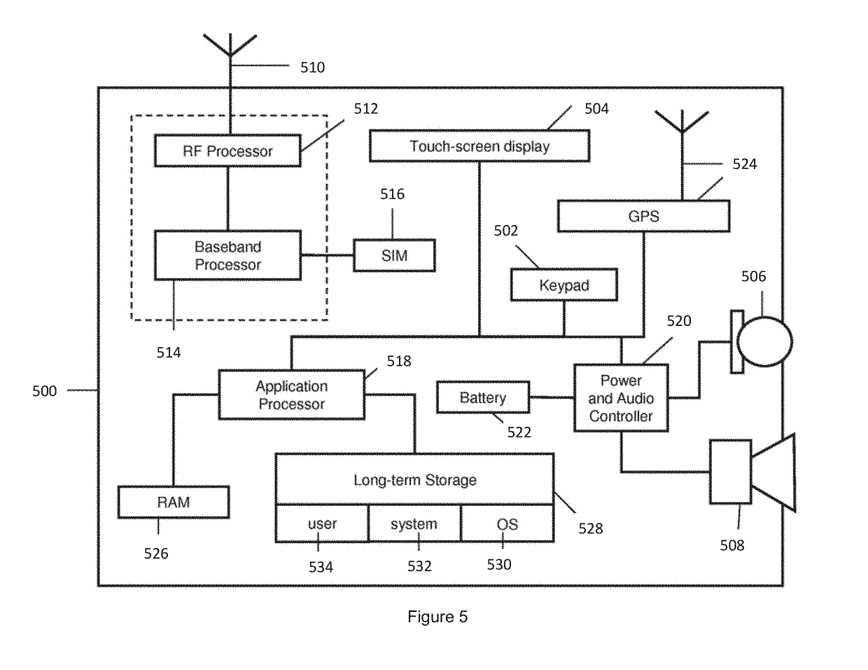

FIG. 5 shows a schematic of an exemplary wireless computing device 500 that may be utilized to implement the customer device (such as 204 in FIG. 2).

The wireless device 500 comprises a keypad 502, a touch-screen 504, a microphone 506, a speaker 508 and an antenna 510. The wireless device 500 is capable of being operated by a user to perform a variety of different functions, such as, for example, hosting a telephone call, sending an SMS message, browsing the Internet, sending an email and providing satellite navigation.

The wireless device 500 comprises hardware to perform communication functions (e.g. telephony, data communication), together with an application processor and corresponding support hardware to enable the wireless device 500 to have other functions, such as, messaging, Internet browsing, email functions and the like. The communication hardware is represented by a radio frequency (RF) processor 55 which provides an RF signal to the antenna 510 for the transmission of data signals, and the receipt therefrom. Additionally provided is a baseband processor 514, which provides signals to and receives signals from the RF Processor 512. The baseband processor 514 also interacts with a subscriber identity module (SIM) 516, as is well known in the art. The communication subsystem enables the wireless device 500 to communicate via a number of different communication protocols including 3G, 4G, GSM, WiFi, Bluetooth™ and/or CDMA. The communication subsystem of the wireless device 500 is beyond the scope of the present invention.

The keypad 502 and the touch-screen 504 are controlled by an application processor 518. A power and audio controller 520 is provided to supply power from a battery 522 to the communication subsystem, the application processor 518, and the other hardware. The power and audio controller 520 also controls input from the microphone 506, and audio output via the speaker 508. Also provided is a global positioning system (GPS) antenna and associated receiver element 524 which is controlled by the application processor 518 and is capable of receiving a GPS signal for use with a satellite navigation functionality of the wireless device 500.

In order for the application processor 518 to operate, various different types of memory are provided. Firstly, the wireless device 500 includes Random Access Memory (RAM) 526 connected to the application processor 518 into which data and program code can be written and read from at will. Code placed anywhere in RAM 526 can be executed by the application processor 518 from the RAM 526. RAM 526 represents a volatile memory of the wireless device 500.

Secondly, the wireless device 500 is provided with a long-term storage 528 connected to the application processor 518. The long-term storage 528 comprises three partitions, an operating system (OS) partition 530, a system partition 532 and a user partition 534. The long-term storage 528 represents a non-volatile memory of the wireless device 500.

In the present example, the OS partition 530 contains the firmware of the wireless device 500 which includes an operating system. Other computer programs may also be stored on the long-term storage 528, such as application programs (also referred to as apps), and the like. In particular, application programs which are mandatory to the wireless device 500, such as, in the case of a smartphone, communications applications and the like are typically stored in the system partition 532. The application programs stored on the system partition 532 would typically be those which are bundled with the wireless device 500 by the device manufacturer when the wireless device 500 is first sold.

Application programs which are added to the wireless device 500 by the user would usually be stored in the user partition 534.

As stated, the representation of FIG. 5 is schematic. In practice, the various functional components illustrated may be substituted into one and the same component. For example, the long-term storage 528 may comprise NAND flash, NOR flash, a hard disk drive or a combination of these.

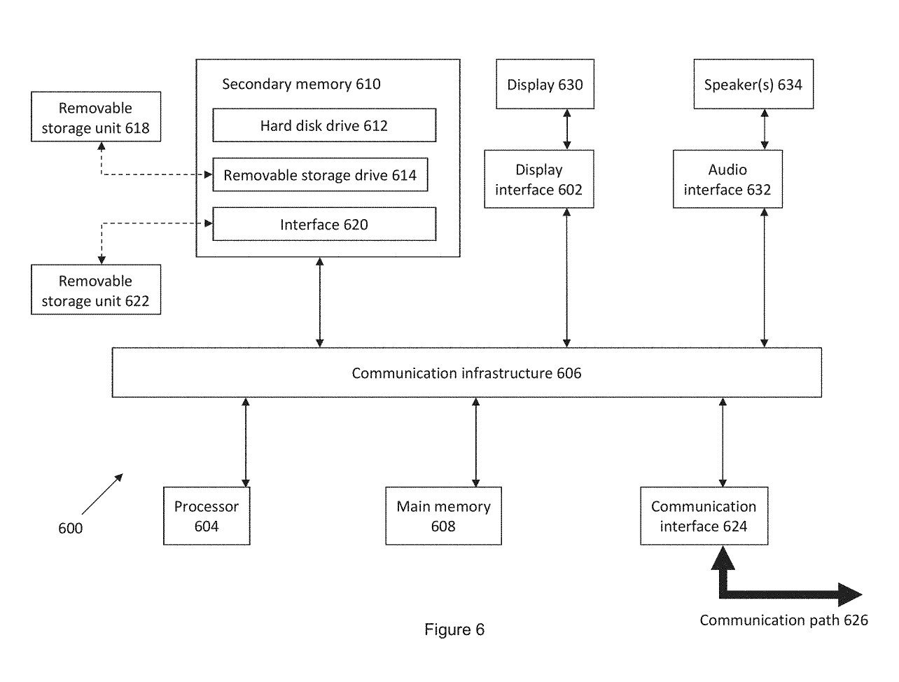

FIG. 6 depicts an exemplary computing device 600, hereinafter interchangeably referred to as a computer system 600, where one or more such computing devices 600 may be used for the system 202 (FIG. 2), the merchant database 206 (FIG. 2) and the card network database 208 (FIG. 2). The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a hard disk drive 612 and/or a removable storage drive 614, which may include a floppy disk drive, a magnetic tape drive, an optical disk drive, or the like. The removable storage drive 614 reads from and/or writes to a removable storage unit 618 in a well-known manner. The removable storage unit 618 may include a floppy disk, magnetic tape, optical disk, or the like, which is read by and written to by removable storage drive 614. As will be appreciated by persons skilled in the relevant art(s), the removable storage unit 618 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 620. Examples of a removable storage unit 622 and interface 620 include a program cartridge and cartridge interface (such as that found in video game console devices), a removable memory chip (such as an EPROM or PROM) and associated socket, and other removable storage units 622 and interfaces 620 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port, an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage unit 618, removable storage unit 622, a hard disk installed in hard disk drive 612, or a carrier wave carrying software over communication path 626 (wireless link or cable) to communication interface 624. Computer readable storage media refers to any non-transitory tangible storage medium that provides recorded instructions and/or data to the computing device 600 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the hard disk drive 612, or the interface 620. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated that the elements illustrated in FIG. 6 function to provide means for performing the various functions and operations of the servers as described in the above embodiments.

In an implementation, a server may be generally described as a physical device comprising at least one processor and at least one memory including computer program code. The at least one memory and the computer program code are configured to, with the at least one processor, cause the physical device to perform the requisite operations.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A system for determining a profile of a consumer, comprising:
a processor; and
a memory unit coupled to the processor,
wherein the memory unit is configured to store the consumer's payment card usage data; and
wherein the processor is configured to:
obtain a credit score specific to the consumer;
calculate a payment card index specific to the consumer based on the consumer's payment card usage data stored in the memory unit, the payment card index comprising a weighted sum of factors representative of the consumer's payment card usage; and
multiply the credit score by the payment card index to obtain a collective score representative of the profile of the consumer.

2. The system as claimed in claim 1, wherein the payment card index comprises a value between 0 and 1, and wherein the factors representative of the consumer's payment card usage each comprise a value between 0 and 1.

3. The system as claimed in claim 1, wherein the factors representative of the consumer's payment card usage comprise a factor representative of a total number of payment cards issued by different payment card issuers to the consumer.

4. The system as claimed in claim 1, wherein the factors representative of the consumer's payment card usage further comprise a factor representative of a number of bad spending records by the consumer.

5. The system as claimed in claim 1, wherein the factors representative of the consumer's payment card usage further comprise a factor representative of a number of payment card transactions made by the consumer within a predetermined period of time.

6. The system as claimed in claim 1, wherein the factors representative of the consumer's payment card usage further comprise a factor representative a number of payment card transactions made by the consumer relative to the consumer's current location.

7. The system as claimed in claim 1,
wherein the memory unit or an additional memory unit is configured to receive data representing the profile of the consumer; and
wherein the processor or an additional processor is configured to analyze the received data and generate merchant information for delivery to the consumer based on the profile of the consumer.

8. The system as claimed in claim 7, wherein the system is further configured to deliver the merchant information to the consumer in real-time based on a location of the consumer.

9. The system is claimed in claim 1,
wherein the memory unit or an additional memory unit is configured to receive payment card application data from the consumer and data representing the profile of the consumer; and
wherein the processor or an additional process is configured to analyze the received data and process the payment card application based on the profile of the consumer.

10. The system as claimed in claim 9, wherein the system is configured to process the payment card application in real-time, and automatically add details of an approved payment card to a digital wallet of the consumer.

11. A method for determining a profile of a consumer, the method comprising:
obtaining, by a processor, a credit score specific to the consumer;
calculating, by the processor, a payment card index specific to the consumer, wherein the payment card index comprises a weighted sum of factors representative of the consumer's payment card usage; and
multiplying, by the processor, the credit score by the payment card index to obtain a collective score representative of the profile of the consumer.

12. The method as claimed in claim 11, wherein the payment card index comprises a value between 0 and 1, and wherein the factors representative of the consumer's payment card usage each comprise a value between 0 and 1.

13. The method as claimed in claim 11, wherein the factors representative of the consumer's payment card usage comprise a factor representative of a total number of payment cards issued by different payment card issuers to the consumer.

14. The method as claimed in claim 11, wherein the factors representative of the consumer's payment card usage further comprise a factor representative of a number of bad spending records by the consumer.

15. The method as claimed in claim 11, wherein the factors representative of the consumer's payment card usage further comprise a factor representative of a number of payment card transactions made by the consumer within a predetermined period of time.

16. The method as claimed in claim 11, wherein the factors representative of the consumer's payment card usage further comprise a factor representative a number of payment card transactions made by the consumer relative to the consumer's current location.

17. The method as claimed in claim 11,
analyzing the profile of the consumer; and
delivering merchant information to the consumer based on the profile of the consumer.

18. The method as claimed in claim 17, wherein the merchant information is delivered to the consumer in real-time based on the consumer's location.

19. The method as claimed in claim 11,
receiving the payment card application from a consumer;
analyzing the profile of the consumer; and
processing the payment card application based on the profile of the consumer.

20. The method as claimed in claim 19, wherein the steps of receiving, analyzing and processing are performed in real-time, and wherein the method further comprises automatically adding details of an approved payment card to a digital wallet of the consumer.
